(19) United States
(12) Patent Application Publication
(10) Pub. No.: US 2024/0142963 A1
(43) Pub. Date: May 2, 2024

(54) PLANT MAINTENANCE MANAGEMENT INFORMATION PROCESSING METHOD AND PROCESSING SYSTEM

(71) Applicant: JGC CORPORATION, Kanagawa (JP)

(72) Inventors: Masayuki TANABE, Kanagawa (JP); Kosuke TAKAISHI, Kanagawa (JP); Kazuyuki NAMBA, Kanagawa (JP)

(73) Assignee: JGC CORPORATION, Kanagawa (JP)

(21) Appl. No.: 18/280,667

(22) PCT Filed: Jul. 5, 2021
(86) PCT No.: PCT/JP2021/025346

§ 371 Date: Sep. 6, 2023

(51) Int. Cl. G05B 23/02; G06F 3/04815; G06F 3/04842

(52) U.S. Cl. CPC G05B 23/0283; G06F 3/04815; G06F 3/04842

(57) ABSTRACT

Provided is a technology for executing information processing with respect to a risk calculated in order to grasp a frequency at which an accident occurs in equipment included in a plant, in a manner that facilitates utilization in safety management of operation of the plant. With regards to processing of maintenance management information of a plant for processing fluid, a plan view of the plant is displayed divided into a plurality of blocks, based on risks of a plurality of accidents assumed to have a possibility of occurring in a plurality of pieces of equipment included in the plant. The plan view is displayed on a monitor with assessment information indicating a result of assessing a risk level attached to each of the blocks. A three-dimensional image about equipment included in a block selected from the plurality of blocks is further displayed on the monitor.

### TECHNICAL FIELD

The present invention relates to a technology for processing maintenance management information of equipment included in a plant.

### BACKGROUND ART

In a plant for processing fluid, a large number of pieces of equipment are installed. When those pieces of equipment fail, not only there is a fear that the plant may fail to normally process the fluid, but also the failure may cause a greater disaster, such as a fire or an environmental pollution. Thus, maintenance work for inspecting or repairing each piece of equipment installed in the plant is performed.

Regarding the maintenance work, an extremely large number of pieces of equipment may be installed in the plant, and hence when every piece of equipment of the plant is inspected or repaired at the same frequency, such work is not efficient because a volume of the work may become enormous.

Thus, hitherto, from the viewpoint of increasing an availability (allowing continued operation of the plant), the following maintenance plan has been created in general. Specifically, the maintenance work is performed at short intervals for equipment having a large impact on the operation of the plant, and the maintenance work is performed at long intervals for equipment having a small impact on the operation of the plant.

However, among pieces of equipment having redundancy, for example, there are some pieces of equipment that have a relatively small impact from the viewpoint of the availability but are important from the viewpoint of increasing safety, for example, prevention of a fire and an environmental pollution. As described above, with the related-art maintenance work, it has been difficult to quantitatively grasp how much the work contributes to the safety of the plant.

The applicant of the present invention has accordingly proposed a method in which a concept of a risk concerning pieces of equipment that are targets of maintenance management is newly defined, and pieces of equipment that are targets of maintenance work and safety devices for preventing accidents are listed based on a result of calculating risks (Patent Literature 1).

Further, the applicant thinks that the new concept of a risk is usable not only for creation of a maintenance plan for equipment but also for predictive safety management in daily operation of the plant.

In Patent Literature 1, there is described a technology for outputting a list of pieces of replacement equipment based on a result of learning a probability distribution related to failures and performance deterioration of equipment included in a plant or the like, through use of maintenance history information of the equipment. In Patent Literature 2, there is described a technology for making a comparison of a plurality of maintenance plans possible by automatically generating a process flow of maintenance based on lifetime information or the like of pipings included in a plant, and presenting the process flow along with an indicator (key performance indicator: KPI) for evaluating this maintenance plan.

However, neither Patent Literature 1 nor Patent Literature 2 includes description of a technology for utilizing an indicator related to maintenance of equipment in safety management of daily operation of a plant.

### CITATION LIST

### Patent Literature

[PTL 1] JP 6821085 B1
[PTL 2] JP 6192727 B2
[PTL 3] JP 2020-190855 A

### SUMMARY OF INVENTION

### Technical Problem

The present invention has been made against the above-mentioned background, and provides a technology for processing information with respect to a risk calculated in order to grasp a frequency of occurrence of accidents in equipment included in a plant, in a manner that facilitates utilization in safety management of operation of the plant.

### Solution to Problem

According to one embodiment of the present invention, there is provided a processing method for maintenance management information of a plant for processing fluid, the processing method including the steps of: storing, in a storage unit, data about a result of calculating a risk for each one of a plurality of accidents assumed to have a possibility of occurring in a plurality of pieces of equipment included in the plant, a plan view, and a three-dimensional image, the risk being a value obtained by multiplying an occurrence frequency of an accident-causing event which is likely to cause the each one of the plurality of accidents and a failure probability of normal operation of a safety device for preventing occurrence of the each one of the plurality of accidents, the plan view displaying the plurality of pieces of equipment included in the plant with the plurality of pieces of equipment divided into a plurality of blocks, the three-dimensional image indicating placement, in the plant, of each of the plurality of pieces of equipment for which the risk is calculated; acquiring, by a computer, the data of the plan view and the risk which are stored in the storage unit, performing image processing of attaching, to each one of the plurality of blocks in the plan view, assessment information indicating a result of assessing a level of the risk calculated for at least one of the plurality of pieces of equipment that is included in the each one of the plurality of blocks, and displaying the plan view with the assessment information attached thereto on a monitor connected to the computer; and receiving, via an input unit connected to the computer, selection of one of the plurality of blocks displayed in the plan view, which is displayed on the monitor, acquiring, by the computer, the data of the three-dimensional image about at least one of the plurality of pieces of equipment that is included in the selected one of the plurality of blocks from the storage unit, and displaying the three-dimensional image on the monitor.

The processing method for maintenance management information of a plant may include the following features.
(a) The assessment information is information indicating in which one of a plurality of risk assessment ranges an indicator calculated for the at least one of the plurality of pieces of equipment is included, the indicator being used to assess the level of the risk, the plurality of risk assessment ranges being created by dividing a possible range in which the indicator fluctuates. Further, the assessment information is colors set in association with the plurality of risk assessment ranges and displayable on the monitor, and the image processing is processing of rendering one of the colors that indicates one of the plurality of risk assessment ranges in which the indicator calculated for the at least one of the plurality of pieces of equipment is included to the each one of the plurality of blocks.
(b) When one of the plurality of blocks includes a plurality of pieces of equipment out of the plurality of pieces of equipment included in the plant, the one of the plurality of blocks is displayed with the assessment information based on an integrated value of the risk that is calculated for each one of the plurality of pieces of equipment attached thereto.
(c) The step of displaying the three-dimensional image on the monitor includes performing image processing of attaching, to one of the plurality of pieces of equipment that is displayed in the three-dimensional image, equipment assessment information indicating a result of assessing highness of the occurrence frequency when the one of the plurality of pieces of equipment is equipment related to the accident-causing event, or a result of assessing highness of the failure probability of normal operation when the one of the plurality of pieces of equipment is the safety device.
(d) The step of storing in the storage unit includes further storing data of a video indicating operation steps of the plant in the storage unit, the operation steps being for a case in which the highness of the occurrence frequency exceeds a level set in advance when the each one of the plurality of pieces of equipment is equipment related to the accident-causing event, or a case in which the highness of the failure probability of normal operation exceeds a level set in advance when the each one of the plurality of pieces of equipment is the safety device, or a case in which an accident related to the pieces of equipment is assumed to occur, and the processing method further includes a step of receiving, via the input unit, selection of one of the plurality of pieces of equipment displayed in the step of displaying the three-dimensional image on the monitor, acquiring, by the computer, data of the video about the selected one of the plurality of pieces of equipment from the storage unit, and displaying the video on the monitor in a replayable manner.

### Advantageous Effects of Invention

The present invention involves displaying, when a plant is displayed on a monitor in a plan view in which the plant is divided into a plurality of blocks, assessment information which indicates a result of assessing risk levels of pieces of equipment included in the respective blocks, along with the plan view. Further, when one of the blocks in the plan view is selected, a three-dimensional image of equipment included in the one of the blocks can be displayed. A configuration and an external shape of each one of piece of equipment placed in a block that has a high risk of accidents, as well as a state of connection between the one of the pieces of equipment and another piece of equipment and the like, can thus be grasped in advance.

### BRIEF DESCRIPTION OF DRAWINGS

FIG. 1 is a block diagram of a processing system for processing maintenance management information of a plant according to an embodiment of the present invention.

FIG. 2 is a configuration example of a maintenance management screen.

FIG. 3 is a maintenance management screen displaying a 3D image of a selected piece of equipment and surroundings thereof.

FIG. 4 is a maintenance management screen displaying a video replay window that indicates operation steps of the plant to be executed in a case of an accident.

### DESCRIPTION OF EMBODIMENTS

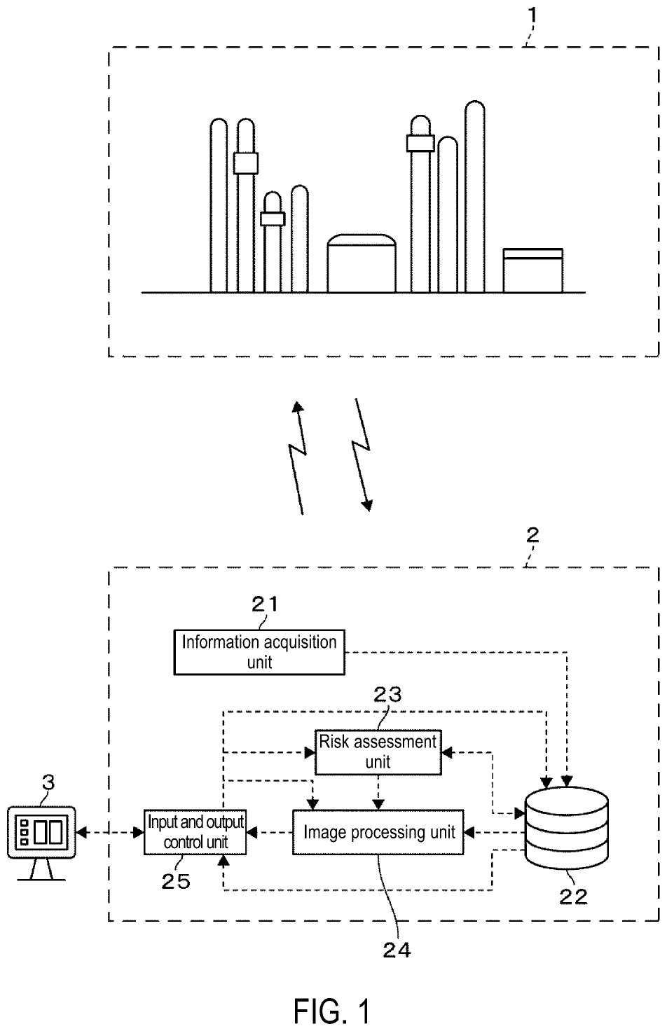

First, referring to FIG. 1, description is given of an overview of a processing system 2 for maintenance management information of a plant (hereinafter simply referred to as “processing system 2”) according to an embodiment of the present invention.

FIG. 1 is a block diagram for illustrating an overview of the processing system 2 of this example and a plant 1. In the plant 1, safety management using the processing system 2 is performed.

There is no particular limitation on the plant 1 as long as the plant 1 has a function of processing fluid. Examples of the plant 1 include: a natural gas plant for, for example, liquefying natural gas and separating and recovering natural gas liquid; a petroleum refinery plant for, for example, distilling and desulfurizing crude oil and various intermediate products; a chemical plant for producing petrochemical products, intermediate chemical products, polymers, and the like; a pharmaceutical plant for producing pharmaceuticals and intermediate products thereof; and a waste processing plant for processing low-level radioactive waste.

In the present application, the “fluid” also includes, in addition to gas and liquid, a granular material having flowability (e.g., powder, grain, and pellet).

In the plant 1, a large number of pieces of equipment are installed, which include various control (instrumentation) devices and electrical devices in addition to a column, a tank, a heat exchanger, and other such static equipment, a pump and other such dynamic equipment, and pipings provided between those pieces of static equipment and dynamic equipment. Those pieces of equipment include equipment for which maintenance work is to be performed based on a maintenance plan created by calculating a risk described below.

The processing system 2 of this example is configured so that, by utilizing a concept of a risk described below, a distribution situation of risks in premises of the plant 1 can be grasped in association with a plan view of the plant 1.

The processing system 2 is constructed by a computer, for example. The computer constructing the processing system 2 may be installed in a main control room, which is located on the premises of the plant 1 to centrally control the plant 1, or may be installed at an office located in a place remote from the premises of the plant 1.

Before description is given of a specific configuration example of the processing system 2, the concept of a risk used in the processing system 2 of this example is described.

The processing system 2 of this example uses, out of information on the equipment of the plant 1, an “occurrence frequency of an accident-causing event” and a “failure probability of normal operation of a safety device” as information required for performing the maintenance management of the equipment.

The accident-causing event is any event that may cause one of extracted accidents. For example, it is assumed that, in a tank for storing fluid, liquid is received and delivered with a liquid level thereof being controlled. At this time, when a failure occurs in a control system for controlling the liquid level, there arises a fear that the liquid may overflow. In this example, the “overflow of liquid” is an assumed accident, and the “failure in the control system” is the accident-causing event.

It is preferred that assumed accidents be extracted exhaustively for each piece of equipment for which the maintenance management is to be performed by the processing system 2. From this viewpoint, it is preferred that assumed accidents be extracted together with an engineer who is familiar with the equipment and processes of the plant 1 through use of a systematic method relating to safety assessment of the plant 1, such as a hazard and operability study (HAZOP) or failure mode and effects analysis (FEMA).

The safety device is one type of device installed in the plant 1 in order to prevent occurrence of an accident even when an accident-causing event occurs. In the above-mentioned example, it is assumed that a liquid-level meter for interlock for stopping reception of liquid is provided separately from a liquid-level meter installed in the control system for controlling the liquid level. In this example, the “liquid-level meter for interlock” is the safety device.

Regarding the accident-causing event described above, the number of times for which a predetermined accident-causing event may occur during a period (one year in this example) set in advance for equipment is the “occurrence frequency.” Further, the number of times for which the safety device may fail to normally operate during a period (one year in this example) set in advance for a safety device is the “failure probability.”

Past records of occurrence of the above-mentioned “accident-causing event” and “safety device failure” are continuously counted in the entire plant industry, and the “occurrence frequency of an accident-causing event of each piece of equipment” and the “failure probability of each safety device,” which are calculated based on those past records, are sold as a database. When the operation of the plant 1 is started, for example, such commercially-available data may be obtained to be stored in a storage unit 22 in association with each assumed accident.

Further, when the user owns other plants of the same type, for example, the “occurrence frequency of an accident-causing event” and the “failure probability of safety device” of the other plants may be used.

Further, after the operation of the plant 1 is started, when the accident-causing event or the failure of the safety device has actually occurred in the plant 1, the “occurrence frequency of an accident-causing event” or the “failure probability of safety device” may be calculated by incorporating records of occurrence of those events. For example, it is possible to incorporate the records of occurrence through use of Bayesian estimation.

Regarding a failure occurrence frequency of equipment (including a case in which the equipment is a safety device), a mean value of a time to failure and a variance thereof based on a lognormal uncertainty distribution are represented by Xmean and Var, respectively. At this time, the time to occurrence of a failure in the equipment can be expressed through use of a suitable probability distribution. For example, a probability density of a gamma distribution can be represented by Expression (1) given below.

$$f ( X , α , β ) = \frac{1}{{β}^{α} Γ ( α )} {X}^{α - 1} {e}^{- ( X / β )} \qquad ( 1 )$$

In this expression, α and β represent (Xmean)²/Var and Xmean/Var, respectively, and Γ represents a gamma (Γ) function.

At this time, for example, when Xmean and Var are regarded as a time to failure described in the commercially-available database and a variance of original data for obtaining the time to failure, respectively, Expression (1) given above can be understood as a change with time of the failure occurrence frequency from an initial state.

For example, it is assumed that the plant 1 includes five pieces of equipment of the same type, and one failure has occurred as a result of operating those equipment for 20 years. It can be regarded that a failure that occurs once in one hundred years has occurred in the equipment. When posterior parameters (Xmean′ and Var′) are calculated based on this record of failure occurrence and the initial state (prior parameters Xmean and Var) through use of Bayesian estimation, the respective posterior parameters can be calculated through use of Expression (2) and Expression (3) given below.

Xmean′=(α0+(Number of Times of Failure Occurrence))/(β0+(Total Operating Time)) (2)

Var′=(α0+(Number of Times of Failure Occurrence))/(β0+(Total Operating Time))² (3)

A change with time of the failure occurrence frequency exhibited after the past record of the equipment failure is incorporated can thus be calculated. In Expression (2) and Expression (3), α0 and β0 are values calculated from Xmean, which is the time to failure written in the database described above, and Var, which is the variance of the original data.

When the above-mentioned method is to be implemented, past records of occurrence of the accident-causing event and the failure of the safety device (the number of times of occurrence and time to occurrence) relating to each piece of equipment installed in the plant 1 are acquired. The processing system 2 also performs the above-mentioned calculation based on the acquired information to obtain the “occurrence frequency of an accident-causing event and failure probability of a safety device” in which the past records of occurrence are incorporated.

The safety device to be managed by the maintenance management system 2 herein is not limited to a safety instrument system (SIS), for example, the above-mentioned “liquid-level meter for interlock.” Also for a safety device other than the safety instrument system, such as a safety valve or an alarm, data on a past record of occurrence of the “safety device failure” is incorporated and updated for use in the maintenance management. In addition to those safety devices, data on the past record of occurrence can similarly be incorporated and updated also for “equipment that may cause accident-causing event (for example, a ‘control valve’ for the above-mentioned liquid level control).”

Next, description is given of contents of a risk calculated through use of the “occurrence frequency of an accident-causing event” and the “failure probability of a safety device” described above. For example, in a case in which a safety device for preventing occurrence of an assumed accident is installed in equipment, even when an accident-causing event occurs, the assumed accident does not occur as long as the safety device normally operates. Further, even under a state in which the safety device does not normally operate, the assumed accident does not occur as long as the accident-causing event does not occur.

That is, the assumed accident occurs when “the accident-causing event occurs” and “the safety device does not normally operate.”

On the basis of the above-mentioned idea, a risk assessment unit 23 calculates a risk of occurrence of the assumed accident through use of Expression (4) given below.

Risk=(Occurrence Frequency of Accident-causing Event)×(Failure Probability of Safety Device) (4)

In some equipment, multiple safety devices may be provided. In this case, the risk assessment unit 23 calculates the risk based on Expression (4)′ given below, in which failure probabilities of respective safety devices are multiplied in order. In Expression (4)′, an exemplary case in which two safety devices (primary safety device and secondary safety device) are included is given.

Risk=(Occurrence Frequency of Accident-causing Event)×(Failure Probability of Primary Safety Device)×(Failure Probability of Secondary Safety Device) (4)′

In this case, for example, when the occurrence frequency and the failure probability are represented as a function of the time to occurrence of a failure, for example, a time point at which the relevant equipment was newly provided, updated, or repaired last is set as a zero point, and values of the occurrence frequency and the failure probability at a current time point are read to calculate the risk.

A risk calculated by the method described above is compared to a threshold value set in advance as an upper limit value of a range of allowable values of that risk. This enables an assessment that a risk of occurrence of an assumed accident exceeds an allowable range when a risk calculated with respect to the assumed accident is greater than the threshold value.

As a result, a piece of equipment and a safety device for which the risk has been calculated can be listed as maintenance target candidates. Creation of a specific maintenance schedule for the piece of equipment and the safety device enables the user of the plant 1 to create and execute a maintenance plan that is organized in association with each assumed accident.

The processing system 2 of this example is further capable of utilizing the result of the risk calculation described above for safety management of daily operation of the plant 1. A configuration relevant to this function is described below with reference to FIG. 1 to FIG. 4.

As illustrated in FIG. 1, the processing system 2 includes an information acquisition unit 21 for acquiring information on equipment of the plant 1, the storage unit 22 for storing various types of information required to execute maintenance management, the risk assessment unit 23 for executing the risk calculation described above and the like based on those pieces of information, an image processing unit 24 for providing information related to safety management to the user by utilizing the calculated risk, and an input and output control unit 25.

The information acquisition unit 21 acquires, out of information on the equipment of the plant 1, the “occurrence frequency of an accident-causing event” and the “failure probability of normal operation of a safety device” described above (a step of storing data). Those pieces of information may be individually input by the user, or may be acquired from a database that is separately provided.

When data is individually input, the information acquisition unit 21 is constructed as an input terminal of the computer, for example. When the data is acquired from the database, the information acquisition unit 21 is constructed as a terminal for reading a storage medium or as a communication unit for performing data communication to and from the outside.

The storage unit 22 stores a database in which values of the “occurrence frequency of an accident-causing event” and the “failure probability of normal operation of a safety device” acquired via the information acquisition unit 21, a value of a risk calculated from those values, and the above-mentioned threshold value for assessing the risk are associated with one another.

The storage unit 22 further stores data of a plan view displaying a large number of pieces of equipment included in the plant 1, with the pieces of equipment divided into a plurality of blocks, data of a three-dimensional (3D) image indicating placement of each piece of equipment in the plant 1, and data of a video indicating operation steps of the equipment. Operation of storing those pieces of data in the storage unit 22 corresponds to the “step of storing data” in this embodiment as well.

The plan view, the 3D image, and the video may be presented on a monitor 3 that is provided directly in the processing system 2. The processing system 2 may also be configured so that the plan view, the 3D image, and the video are presented to the user on the monitor 3 that is connected to the processing system 2 via a communication network, for example, a client computer or a tablet terminal.

Prior to the presentation to the user, the plan view and the 3D image of the plant 1 receive image processing for associating the plan view and the 3D image with assessment information, which indicates a result of assessing a risk level calculated for each piece of equipment in the plant 1.

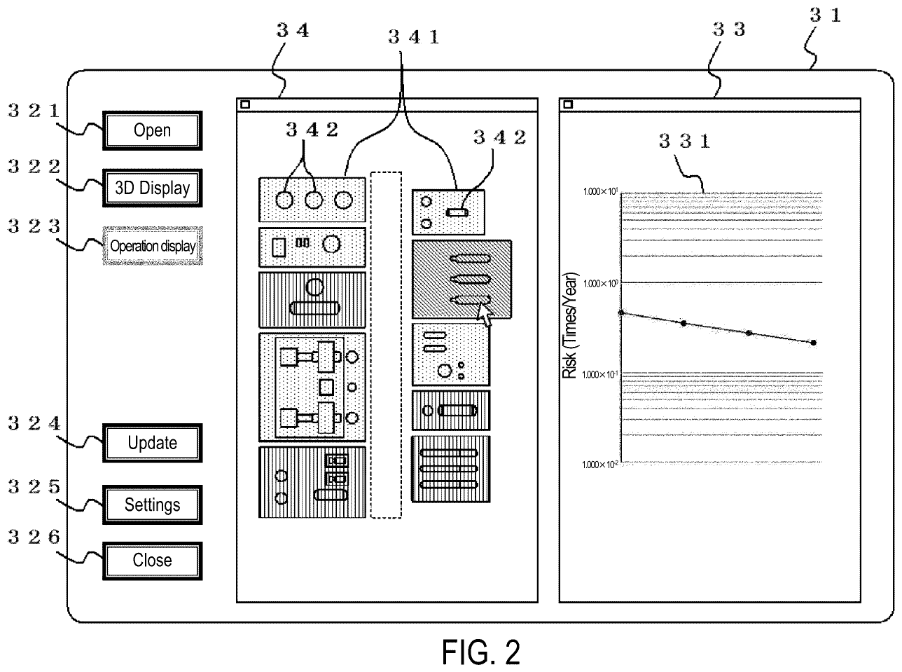

For example, as illustrated in a risk map window 34 of FIG. 2, the plan view of the plant 1 in this example is a diagram for schematically displaying blocks 341, which are a plurality of areas created by dividing the premises in accordance with placement of the pieces of equipment of the plant 1 in the premises. Generally speaking, in the plant 1 having a large number of pieces of equipment, the large number of pieces of equipment are divided into a plurality of groups by purposes of introducing the equipment such as processing of a process fluid and supply of utilities, or by the order of processing fluid, or by relativity between the pieces of equipment. Pieces of equipment forming each equipment group are placed together in a shared area in many cases.

The plan view of the plant 1 is displayed divided into the plurality of blocks 341 so as to correspond to placement of such equipment groups. As illustrated in FIG. 2, in each one of the blocks 341, main equipment 342 in the one of the blocks 341 may be schematically displayed in the plan view.

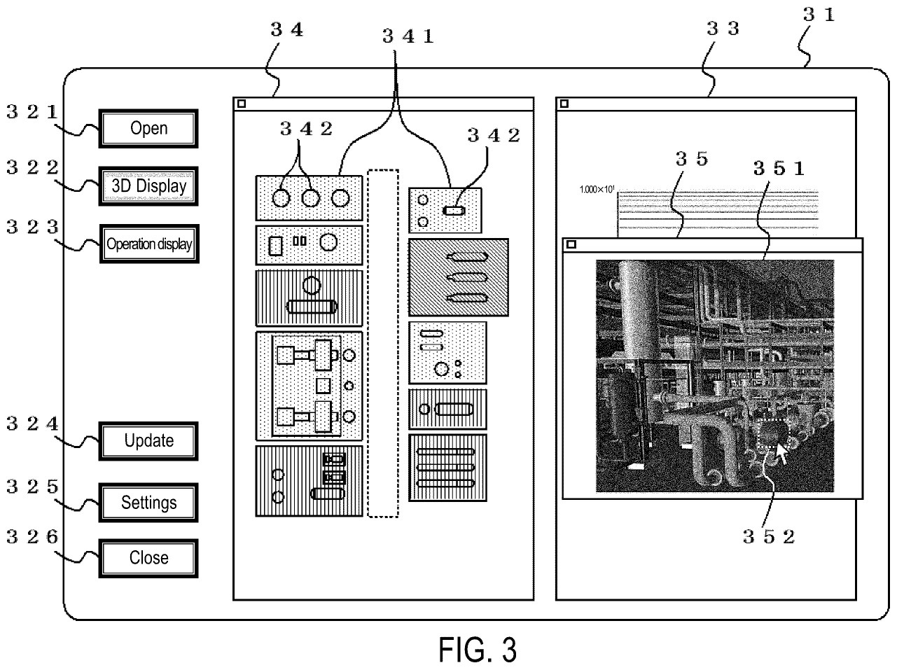

As illustrated in a 3D display window 35 of FIG. 3, for example, an external appearance (external shapes and placed positions of pieces of equipment, and connection relationships of the pieces of equipment connected via pipings) of the plant 1 viewed by a person standing in the premises is three-dimensionally displayed in a 3D image 351. For the 3D image 351, 3D computer-aided design (3D-CAD) data created when the plant 1 is designed is usable. With the use of the 3D-CAD data, operation such as a shift of the point of view and zoom in or zoom out can freely be performed.

Further, the video includes an animation or a photographed image depicting operation steps of the plant 1 to be executed in case of an accident assumed to occur (assumed accident) when an accident-causing event related to the risk described above happens.

For example, it is assumed that, in the above-mentioned tank storing fluid, an accident-causing event that is a failure of the control system for controlling the liquid level has happened and an assumed accident that is an overflow of liquid has occurred. In this case, for example, videos for “stopping a supply pump that supplies the fluid to the storage tank” and “putting a drainage pump into operation to discharge the liquid overflowing from a drainage channel around the storage tank” are prepared in advance.

Videos stored in the storage unit 22 may include a video about operation steps of the plant 1 to be executed when the risk level of equipment exceeds a level set in advance.

An example of the operation steps is “operation of immediately stopping a supply pump that supplies fluid to a relevant storage tank when a liquid level alarm of the storage tank sounds” in a case in which the risk of an overflow of liquid increases with a failure of the control system for controlling the liquid level (an accident-causing evet). When the system failure actually happens, the overflow of the liquid can thus be avoided.

Returning to the description of FIG. 1, the risk assessment unit 23 calculates a risk by the method described above, through use of the “occurrence frequency of an accident-causing event” and the “failure probability of normal operation of a safety device (failure probability of a safety device)” acquired via the information acquisition unit 21. The risk assessment unit 23 may also calculate changes with time of the occurrence frequency of the accident-causing event and the failure probability of the safety device by the method described above with use of Expression (2) and Expression (3), and calculate, from a result thereof, changes with time of the risk. The changes with time of the risk are presented to the user in the form of, for example, a risk trend graph 331 as illustrated in a risk display window 33 of FIG. 2.

The risk assessment unit 23 of this example further calculates, as information to be attached to the plan view of the plant 1, for each one of the blocks 341, assessment information indicating a result of assessing levels of a risk calculated with respect to pieces of equipment included in the one of the blocks 341. In calculation of the assessment information, the risk assessment unit 23 acquires, from the storage unit 22, for each one of the blocks 341 in the plan view, current risk values calculated with respect to the plurality of pieces of equipment included in the one of the blocks 341. The risk assessment unit 23 then calculates, for each one of the blocks 341, an integrated value in which those risk values are integrated. In this example, an integrated value of risk values that is calculated for one of the blocks 341 corresponds to an index for assessing the risk level in the one of the blocks 341.

The risk assessment unit 23 next performs assessment indicating highness of the integrated value of risks described above. For each one of the blocks 341, a possible range of fluctuations of the integrated value of risks is set in advance, and this fluctuation range is divided into a plurality of risk assessment ranges. The risk assessment unit 23 identifies which of the risk assessment ranges the calculated integrated value of risks falls into, and outputs a result of the identification to the image processing unit 24 in association with identification information of the one of the blocks 341. For example, when the fluctuation range of the integrated value of risks is divided into three stages of risk assessment ranges, information corresponding to one of “1”, which indicates the risk assessment range at the lowest stage, to “3”, which indicates the risk assessment range at the highest stage, is output to the image processing unit 24.

In addition, when a piece of equipment 352 displayed in the 3D image 351 shown in FIG. 3 is equipment related to an accident-causing event for calculating the risk, or when the displayed piece of equipment is a safety device, the risk assessment unit 23 of this example assesses highness of the occurrence frequency of the accident-causing event or highness of the failure probability of the safety device, and calculates equipment assessment information indicating a result of the assessment. In calculation of the equipment assessment information, when pieces of equipment associated with the occurrence frequency of the accident-causing event and the failure probability of the safety device are included in the displayed 3D image 351, the risk assessment unit 23 acquires values of the occurrence frequency and the failure probability from the storage unit 22.

For instance, in the example of the overflow of the liquid described above, when the control system of the storage tank is included in the 3D image 351, the risk assessment unit 23 acquires the current value of the occurrence frequency related to the control system. When the liquid level meter for interlock of the storage tank described above is included in the 3D image 351, the risk assessment unit 23 acquires the current value of the failure probability of operation of detecting the liquid level in the storage tank with the liquid level meter.

The risk assessment unit 23 next assesses, for the piece of equipment 352 displayed in the 3D image 351, the highness of the occurrence frequency of the accident-causing event or the highness of the failure probability of the safety device. With respect to each of the pieces of equipment for which the values of the occurrence frequency of the accident-causing event and the failure probability of the safety device have been acquired, a possible range in which the acquired value fluctuates is set in advance, and the fluctuation range is divided into a plurality of assessment ranges. The risk assessment unit 23 identifies which of the assessment ranges the acquired value of the occurrence frequency of the accident-causing event or the failure probability of the safety device falls into, and outputs a result of the identification to the image processing unit 24 in association with identification information of the one of the pieces of equipment. A setting example of the assessment ranges is, for example, the same as the above-mentioned setting example of the risk assessment ranges (three stages of from “1” to “3”) for the assessment information in each of the blocks 341 of the plan view.

Functions of the image processing unit 24 are described next. Before the plan view of the plant 1 is displayed on the monitor 3, the image processing unit 24 executes, for each of the blocks 341, image processing for attaching assessment information that indicates an assessment result of the assessment information (the integrated value of risks) acquired from the risk assessment unit 23. The image processing unit 24 of this example executes image processing for rendering colors of “blue, yellow, and red” displayable on the monitor 3 in association with the above-mentioned risk assessment ranges (numbers of three stages of from “1” to “3”) for evaluating the assessment information. This image processing enables each of the blocks 341 to be displayed with the assessment information based on the integrated value of risks that has been calculated in the risk assessment unit 23 attached thereto when the plan view of the plant 1 is displayed in the risk map window 34 of FIG. 2.

The image processing unit 24 further executes, before the selected 3D image 351 is displayed on the monitor 3, with respect to a piece of equipment for which the occurrence frequency of the accident-causing event or the failure probability of the safety device has been acquired, image processing for attaching assessment information that indicates an assessment result of the equipment assessment information (a value of the occurrence frequency of the accident-causing event or the failure probability of the safety device) acquired from the risk assessment unit 23. The image processing unit 24 of this example executes image processing for rendering colors of “blue, yellow, and red” in association with the above-mentioned assessment ranges (numbers of three stages of from “1” to “3”) for evaluating the equipment assessment information. This image processing enables each piece of equipment 352 to be displayed with the equipment assessment information based on the above-mentioned highness of the occurrence frequency or the failure probability acquired in the risk assessment unit 23 attached thereto when the 3D image 351 is displayed in the 3D display window 35 of FIG. 3.

The input and output control unit 25 receives, via an input unit connected to the processing system 2, display commands to display the plan view of the plant 1, the 3D image 351, and the video indicating operation steps of equipment to be executed when an accident happens. In a case in which the monitor 3 is connected directly to the processing system. 2, the monitor 3 itself which forms a touch panel display, a keyboard, or the like corresponds to the input unit. Ina case in which the processing system 2 and the monitor 3 are connected via a communication network, communication means (not shown) provided in the processing system 2 corresponds to the input unit.

When receiving a display command to display the plan view of the plant 1 or the 3D image 351, the input and output control unit 25 outputs the display command to the risk assessment unit 23 or the image processing unit 24. The risk assessment unit 23 acquires values of a risk of each piece of equipment, the occurrence frequency of the accident-causing event, and the failure probability of the safety device that are stored in the storage unit 22, based on the acquired display command. The risk assessment unit 23 then identifies the assessment information and the device assessment information about the integrated value of risks of a relevant one of the blocks 341, and about the highness of the occurrence frequency of the accident-causing event, or the highness of the failure probability of the safety device, of the equipment 352 displayed in the 3D image 351, and outputs the identified information to the image processing unit 24. Instead of outputting the calculated assessment information and equipment assessment information directly to the image processing unit 24, the assessment information and the equipment assessment information may be stored in the storage unit 22 in association with identification information of each of the blocks 341 and each piece of equipment when, for example, the risk is calculated or when the occurrence frequency of the accident-causing event and the failure probability of the safety device are acquired.

The image processing unit 24 also acquires data of the plan view and data of the 3D image 351 which are stored in the storage unit 22, based on the acquired display command. The image processing unit 24 then executes image processing for rendering colors depending on the assessment information and the equipment assessment information acquired from the risk assessment unit 23 or from the storage unit 22, and outputs the data to the input and output control unit 25.

The input and output control unit 25 outputs, to the monitor 3, the data of the plan view and the data of the 3D image 351 that have been acquired from the image processing unit 24 so that the plan view and the 3D image 351 are displayed in a predetermined display format in, for example, the risk map window 34 illustrated in FIG. 2 and the 3D display window 35 of FIG. 3, respectively. In terms of this, the input and output management unit 25 in this embodiment has a function of an “output control unit” in the present invention.

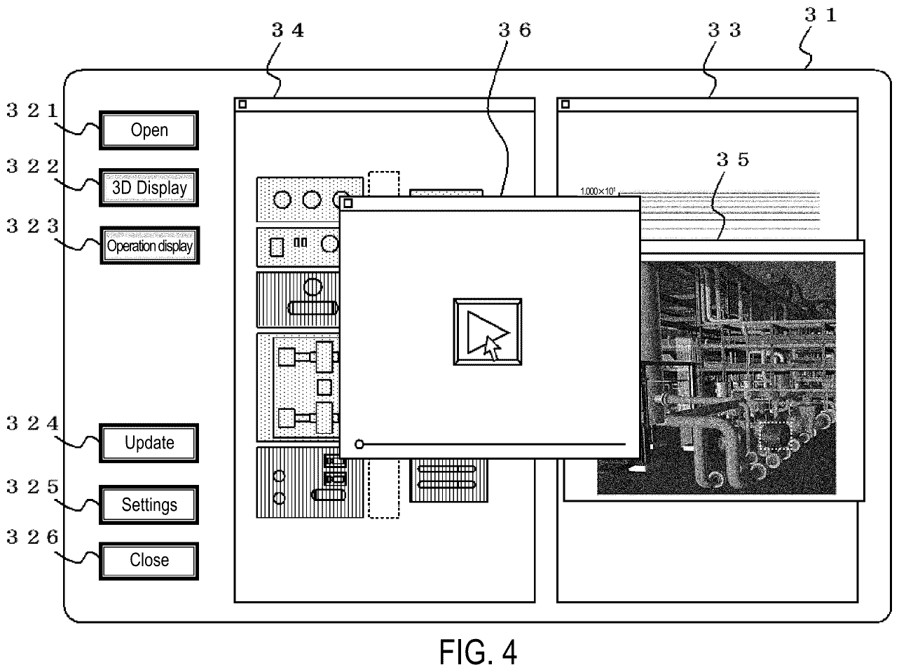

In addition, the input and output control unit 25 reads out video data stored in the storage unit 22 in association with a selected piece of equipment when a display command to display video data is received. The read data is sequentially output to the monitor 3 so as to be displayed in a video display window 36 illustrated in FIG. 4.

The operation of the risk assessment unit 23, the image processing unit 24, and the input and output control unit 25 described above is executed based on settings of a program stored in the storage unit 22.

Operation of the processing system 2 having the configuration described above is described with reference to FIG. 2 to FIG. 4. Those drawings show a configuration example of a maintenance management screen 31 displayed on the monitor 3 that is configured as a touch panel display.

In the maintenance management screen 31 illustrated in FIG. 2 to FIG. 4, a button painted in solid gray is a button for operation that is being executed. A grayed out button is a button inoperative at the time.

As illustrated in FIG. 2, the maintenance management screen 31 of this example includes six buttons of buttons 321 to 326, which are a part of the input unit.

An “open” button 321 is a button for opening a window (not shown) in which the plant 1 to be managed through use of the maintenance management screen 31 is selected. The “open” button 321 is used when, for example, more than one plant 1 is provided in shared factory premises, or when one plant 1 and another plant 1 which are provided in different regions are managed from a remote site.

A 3D display button 322 is a button for specifying one of the blocks 341 displayed in the risk map window 34, and displaying the 3D image 351 of equipment included in the one of the blocks 341.

An operation display button 323 is a button for specifying a piece of equipment 352 displayed in the 3D image 351, and displaying a video that shows operation steps executed when an accident happens in the piece of equipment and when the value of the occurrence frequency of an accident-causing event related to the accident, or the value of the failure probability of normal operation of a safety device related to the accident, increases.

An update button 324 is a button for registering a result of editing when, for example, values of the “occurrence frequency of an accident-causing event” and the “failure probability of normal operation of a safety device” stored in the storage unit 22 via the maintenance management screen 31 and values of parameters in Expression (1) to Expression (3) for calculating changes with time of a risk are input or edited. This operation enables updating of contents displayed in the windows 33 to 35 of the maintenance management screen 31.

A settings button 325 is a button for changing display settings and the like of the windows 33 to 36 via the maintenance management screen 31. A “close” button 326 is a button for closing the maintenance management screen 31.

When the “open” button 321 is pressed with the maintenance management screen 31 displayed, the selection window (not shown) is opened. When one plant 1 is selected out of plants listed in the selection window, the risk map window 34 displaying a plan view of the selected plant 1 is opened.

In the plan view displayed in the risk map window 34, the plant 1 is blocked into the plurality of blocks 341 as described above, and one of colors “blue, yellow, and red” which are assessment information based on the integrated value of risks is rendered to each of the blocks 341 (a step of displaying, on the monitor 3, the blocks 341 with the assessment information attached thereto). In FIG. 2 to FIG. 4, each of the blocks 341 is displayed in one of a dot pattern in place of the color blue, a vertical line pattern in place of the color yellow, and a diagonal line pattern in place of the color red for the sake of convenience of illustration.

When one of the blocks 341 displayed in the risk map window 34 is selected, the selection window (not shown) displaying a list of pieces of equipment for which risk calculation is being executed is opened. With selection of a specific piece of equipment from the selection window, the monitor 3 displays the risk trend graph 331. Changes with time of a risk predicted for the selected piece of equipment can be checked on the risk trend graph 331. The threshold value described above may be written in the risk trend graph 331 alongside the changes with time.

When one of the blocks 341 of the risk map window 34 is selected with the 3D display button 322 pressed, the 3D display window 35 is opened (a step of displaying the 3D image 351 on the monitor 3: FIG. 3). As described above, when the 3D image 351 utilizes 3D-CAD data, operation such as a shift of the point of view and zoom in or zoom out can freely be performed by moving a pointer in the 3D display window 35 or the like. As a result, an external shape and a placed position of a piece of equipment 352 to be checked, a placement relationship between the piece of equipment 352 and another piece of equipment, connection states of pipings, and the like can freely be displayed with use of the 3D image 351.

In the 3D image 351 displayed in the 3D display window 35, one of the colors “blue, yellow, and red” which are equipment assessment information based on the highness of values of the occurrence frequency of the accident-causing event and the failure probability of normal operation of the safety device is rendered to any piece of equipment 352 for which the occurrence frequency of the accident-causing event or the failure probability of normal operation of the safety device has been acquired. In FIG. 3 and FIG. 4, the piece of equipment 352 to which the assessment information is attached is encircled by a broken line for the sake of convenience of illustration.

When the 3D display window 35 is opened, gray-out display of the operation display button 323 is canceled and becomes an operable state. Then, when a piece of equipment 352 of the 3D display window 35 is selected with the operation display button 323 pressed, the video display window 36 is opened (a step of displaying a video on the monitor 3 in a replayable manner: FIG. 4). A configuration in which a window (not shown) for selecting a video is opened when a plurality of videos are registered for one piece of equipment 352 may be employed.

When an operation button displayed in the video display window 36 is pressed to replay a video, a video depicting operation steps of the plant 1 to be executed when an accident assumed for the selected piece of equipment 352 happens and when the value of the occurrence frequency of an accident-causing event related to the accident, or the value of the failure probability of a safety device related to the accident, increases is replayed.

The processing system 2 according to this embodiment has following effects. When a plan view of the plant 1 in which the plant 1 is divided into the plurality of blocks 341 is displayed on the monitor 3, assessment information (color information) indicating a result of assessing risk levels (the integrated value of risks) of pieces of equipment included in each of the blocks 341 is additionally written. Further, selection of one of the blocks 341 in the plan view is received and the 3D image 351 about pieces of equipment included in the selected one of the blocks 341 can be displayed. This enables an operator to grasp, in advance, a configuration and an external shape of each piece of equipment 352 placed in one of the blocks 341 that has a relatively high risk of accidents, as well as a state of connection between the piece of equipment 352 and another piece of equipment, and the like.

For a piece of equipment 352 that is displayed in the 3D image 351 as well, equipment assessment information (color information) indicating a result of assessing the highness of the occurrence frequency of the accident-causing event or the failure probability of normal operation of the safety device is additionally written. This enables the operator to learn, in advance, by selecting a piece of equipment 352 that is a cause of an increase in a risk of an accident, contents of operation of the plant 1 to be executed when the accident happens, and when the occurrence frequency of an accident-causing event related to the accident or the failure probability of normal operation of a safety device related to the accident rises.

Information indicating operation to be executed in case of an accident or the like is not limited to videos. For example, an operation manual expressed in text and drawings may be displayed in the maintenance management screen 31.

The risk map window 34 may be configured so as to be deployable in a multiple manner. For example, a configuration in which, when specific one of the blocks 341 displayed in the risk map window 34 of FIG. 2 is selected, a new risk map window 34 is opened may be employed. In the new risk map window 34, pieces of equipment provided in the selected one of the blocks 341 are displayed further divided into a plurality of blocks (detail blocks), and assessment information (in this example, colors “blue, yellow, and red”) based on the integrated value of risks of pieces of equipment included in each of the detail blocks is attached. In this case, the assessment information of the originally selected one of the blocks 341 may be displayed alongside as, for example, a color of a frame line indicating an area in which the detail blocks are placed.

In another employable configuration, when the 3D display window 35 is opened, a 3D bird's eye view viewed from above equipment in the plant 1 is displayed as an initial image so that an association relationship to the blocks 341 displayed in the risk map window 34 can be visually understood. Operation of shifting the point of view to a piece of equipment to be checked or zooming in from a state in which this 3D bird's eye view is displayed is executed, to thereby be able to grasp a placed position and the like of the target piece of equipment in the plant 1 in a comprehensive manner.

In this case, in the 3D bird's eye view, the risk assessment information (in this example, colors “blue, yellow, and red”) described above may be attached to the interior of an entire area associated with each of the blocks 341. The colors rendered to the blocks 341 may be translucent so that a color corresponding to the equipment assessment information attached to each individual piece of equipment 352 can be checked concurrently.

The assessment information written alongside the blocks 341 displayed in the risk map window 34, and the equipment assessment information written alongside each piece of equipment 352 in the 3D image 351 displayed in the 3D display window 35, are not limited to the case in which different colors are rendered as described above. For example, symbols associated with risk levels such as “1, 2, 3 . . . ” or “A, B, C . . . ” may be attached. To give another example, the integrated value of risks and the values of the occurrence frequency of the accident-causing event and the failure probability of normal operation of the safety device may be written as numerical values alongside the 3D image 351 and the equipment 352. The additionally written numerical values may further be color-coded based on corresponding risk assessment ranges, for example.

When one of the blocks 341 includes a plurality of pieces of equipment, an indicator indicating the risk level of the one of the blocks 341 is not limited to the integrated value of risks with respect to the plurality of pieces of equipment. For example, a value of a risk of one of the plurality of pieces of equipment that has the highest risk may be used as an indicator for assessing risk levels of the pieces of equipment included in the one of the blocks 341. In this case, for example, assessment information based on a result of assessing the highest value out of a plurality of calculated risk values is written alongside each of the blocks 341.

In the example illustrated in FIG. 1, a function of the storage unit 22 for storing a result of calculating a risk of equipment, the plan view of the plant 1, the 3D image 351, and data of the videos, and functions of the risk assessment unit 23, the image processing unit 24, and the input and output control unit 25 are configured in the processing system 2 constructed from a shared computer.

The configuration of the processing system 2 of this embodiment is not limited to this example.

For example, the storage unit 22 may be provided on a server side of a client-server system, with a computer or a tablet terminal on a client side which has functions of the risk assessment unit 23, the image processing unit 24, and the input and output control unit 25 serving as the processing system 2. The same applies to a case in which the function of the storage unit 22 is provided on a cloud side of a cloud system.

In those examples, a result of calculating a risk, the plan view of the plant 1, the 3D image 351, and data of the videos are acquired via a communication unit provided in the storage unit 22.

### REFERENCE SIGNS LIST

1 plant
2 processing system
21 information acquisition unit
22 storage unit
23 risk assessment unit
24 image processing unit
25 output control unit
3 monitor

1. A processing method for maintenance management information of a plant for processing fluid, the processing method comprising the steps of:
storing, in a storage unit, data about a result of calculating a risk for each one of a plurality of accidents assumed to have a possibility of occurring in a plurality of pieces of equipment included in the plant, a plan view, and a three-dimensional image, the risk being a value obtained by multiplying an occurrence frequency of an accident-causing event which is likely to cause the each one of the plurality of accidents and a failure probability of normal operation of a safety device for preventing occurrence of the each one of the plurality of accidents, the plan view displaying the plurality of pieces of equipment included in the plant with the plurality of pieces of equipment divided into a plurality of blocks, the three-dimensional image indicating placement, in the plant, of each of the plurality of pieces of equipment for which the risk is calculated;
acquiring, by a computer, the data of the plan view and the risk which are stored in the storage unit, performing image processing of attaching, to each one of the plurality of blocks in the plan view, assessment information indicating a result of assessing a level of the risk calculated for at least one of the plurality of pieces of equipment that is included in the each one of the plurality of blocks, and displaying the plan view with the assessment information attached thereto on a monitor connected to the computer; and
receiving, via an input unit connected to the computer, selection of one of the plurality of blocks displayed in the plan view, which is displayed on the monitor, acquiring, by the computer, the data of the three-dimensional image about at least one of the plurality of pieces of equipment that is included in the selected one of the plurality of blocks from the storage unit, and displaying the three-dimensional image on the monitor.

2. The processing method for maintenance management information of a plant according to claim 1, wherein the assessment information is information indicating in which one of a plurality of risk assessment ranges an indicator calculated for the at least one of the plurality of pieces of equipment is included, the indicator being used to assess the level of the risk, the plurality of risk assessment ranges being created by dividing a possible range in which the indicator fluctuates.

3. The processing method for maintenance management information of a plant according to claim 2,
wherein the assessment information is colors set in association with the plurality of risk assessment ranges and displayable on the monitor, and
wherein the image processing is processing of rendering one of the colors that indicates one of the plurality of risk assessment ranges in which the indicator calculated for the at least one of the plurality of pieces of equipment is included to the each one of the plurality of blocks.

4. The processing method for maintenance management information of a plant according to claim 1, wherein, when one of the plurality of blocks includes a plurality of pieces of equipment out of the plurality of pieces of equipment included in the plant, the one of the plurality of blocks is displayed with the assessment information based on an integrated value of the risk that is calculated for each one of the plurality of pieces of equipment attached thereto.

5. The processing method for maintenance management information of a plant according to claim 1, wherein the step of displaying the three-dimensional image on the monitor includes performing image processing of attaching, to one of the plurality of pieces of equipment that is displayed in the three-dimensional image, equipment assessment information indicating a result of assessing highness of the occurrence frequency when the one of the plurality of pieces of equipment is equipment related to the accident-causing event, or a result of assessing highness of the failure probability of normal operation when the one of the plurality of pieces of equipment is the safety device.

6. The processing method for maintenance management information of a plant according to claim 1,
wherein the step of storing in the storage unit includes further storing data of a video indicating operation steps of the plant in the storage unit, the operation steps being for a case in which the highness of the occurrence frequency exceeds a level set in advance when the each one of the plurality of pieces of equipment is equipment related to the accident-causing event, or a case in which the highness of the failure probability of normal operation exceeds a level set in advance when the each one of the plurality of pieces of equipment is the safety device, or a case in which an accident related to the pieces of equipment is assumed to occur, and
wherein the processing method further comprises a step of receiving, via the input unit, selection of one of the plurality of pieces of equipment displayed in the step of displaying the three-dimensional image on the monitor, acquiring, by the computer, data of the video about the selected one of the plurality of pieces of equipment from the storage unit, and displaying the video on the monitor in a replayable manner.

7. A processing system for maintenance management information of a plant for processing fluid, the processing system comprising:
a storage unit configured to store data about a result of calculating a risk for each one of a plurality of accidents assumed to have a possibility of occurring in a plurality of pieces of equipment included in the plant, a plan view, and a three-dimensional image, the risk being a value obtained by multiplying an occurrence frequency of an accident-causing event which is likely to cause the each one of the plurality of accidents and a failure probability of normal operation of a safety device for preventing occurrence of the each one of the plurality of accidents, the plan view displaying the plurality of pieces of equipment included in the plant with the plurality of pieces of equipment divided into a plurality of blocks, the three-dimensional image indicating placement, in the plant, of each of the plurality of pieces of equipment for which the risk is calculated;
an image processing unit configured to acquire the data of the plan view and the risk from the storage unit, perform image processing of attaching, to each one of the plurality of blocks in the plan view, assessment information indicating a result of assessing a level of the risk calculated for at least one of the plurality of pieces of equipment that is included in the each one of the plurality of blocks, and display the plan view with the assessment information attached thereto on a monitor;
an input unit configured to receive selection of one of the plurality of blocks displayed in the plan view, which is displayed on the monitor; and
an output control unit configured to acquire the data of the three-dimensional image about at least one of the plurality of pieces of equipment that is included in the one of the plurality of blocks that is selected via input unit from the storage unit, and display the three-dimensional image on the monitor.

8. A processing system for maintenance management information of a plant for processing fluid, the processing system comprising:
a communication unit configured to acquire, through communication to and from an outside, data about a result of calculating a risk for each one of a plurality of accidents assumed to have a possibility of occurring in a plurality of pieces of equipment included in the plant, a plan view, and a three-dimensional image, the risk being a value obtained by multiplying an occurrence frequency of an accident-causing event which is likely to cause the each one of the plurality of accidents and a failure probability of normal operation of a safety device for preventing occurrence of the each one of the plurality of accidents, the plan view displaying the plurality of pieces of equipment included in the plant with the plurality of pieces of equipment divided into a plurality of blocks, the three-dimensional image indicating placement, in the plant, of each of the plurality of pieces of equipment for which the risk is calculated;
an image processing unit configured to acquire, via the communication unit, the data of the plan view and the risk, and perform image processing of attaching, to each one of the plurality of blocks in the plan view, assessment information indicating a result of assessing a level of the risk calculated for at least one of the plurality of pieces of equipment that is included in the each one of the plurality of blocks, and display the plan view with the assessment information attached thereto on a monitor;
an input unit configured to receive selection of one of the plurality of blocks displayed in the plan view, which is displayed on the monitor; and
an output control unit configured to acquire, via the communication unit, the data of the three-dimensional image about at least one of the plurality of pieces of equipment that is included in the one of the plurality of blocks that is selected via the input unit, and display the three-dimensional image on the monitor.

9. The processing system for maintenance management information of a plant according to claim 7, wherein the assessment information is information indicating in which one of a plurality of risk assessment ranges an indicator calculated for the at least one of the plurality of pieces of equipment is included, the indicator being used to assess the level of the risk, the plurality of risk assessment ranges being created by dividing a possible range in which the indicator fluctuates.

10. The processing system for maintenance management information of a plant according to claim 9,
wherein the assessment information is colors set in association with the plurality of risk assessment ranges and displayable on the monitor, and
wherein the image processing unit is configured to execute processing of rendering one of the colors that indicates one of the plurality of risk assessment ranges in which the indicator calculated for the at least one of the plurality of pieces of equipment is included to the each one of the plurality of blocks.

11. The processing system for maintenance management information of a plant according to claim 7, wherein, when one of the plurality of blocks includes a plurality of pieces of equipment out of the plurality of pieces of equipment included in the plant, the image processing unit is configured to execute image processing so that the one of the plurality of blocks is displayed with the assessment information based on an integrated value of the risk that is calculated for each one of the plurality of pieces of equipment attached thereto.

12. The processing system for maintenance management information of a plant according to claim 7, wherein, when the three-dimensional image is displayed on the monitor by the output control unit, the image processing unit is configured to perform image processing of attaching, to one of the plurality of pieces of equipment that is displayed in the three-dimensional image, equipment assessment information indicating a result of assessing highness of the occurrence frequency when the one of the plurality of pieces of equipment is equipment related to the accident-causing event, or a result of assessing highness of the failure probability of normal operation when the one of the plurality of pieces of equipment is the safety device.

13. The processing system for maintenance management information of a plant according to claim 7,
wherein the storage unit is further configured to store a video indicating operation steps of the plant, the operation steps being for a case in which the highness of the occurrence frequency exceeds a level set in advance when the each one of the plurality of pieces of equipment is equipment related to the accident-causing event, or a case in which the highness of the failure probability of normal operation exceeds a level set in advance when the each one of the plurality of pieces of equipment is the safety device, or a case in which an accident related to the pieces of equipment is assumed to occur, and
wherein the input unit is configured to receive selection of one of the plurality of pieces of equipment having the three-dimensional image displayed on the monitor, and the output control unit is configured to acquire data of the video about the selected one of the plurality of pieces of equipment from the storage unit, and display the video on the monitor in a replayable manner.

14. The processing system for maintenance management information of a plant according to claim 8,
wherein the communication unit is further configured to acquire, through the communication to and from the outside, a video indicating operation steps of the plant, the operation steps being for a case in which the highness of the occurrence frequency exceeds a level set in advance when the each one of the plurality of pieces of equipment is equipment related to the accident-causing event, or a case in which the highness of the failure probability of normal operation exceeds a level set in advance when the each one of the plurality of pieces of equipment is the safety device, or a case in which an accident related to the pieces of equipment is assumed to occur, and
wherein the input unit is configured to receive selection of one of the plurality of pieces of equipment having the three-dimensional image displayed on the monitor, and the output unit is configured to acquire data of the video about the selected one of the plurality of pieces of equipment via the communication unit, and display the video on the monitor in a replayable manner.

15. The processing system for maintenance management information of a plant according to claim 8, wherein the assessment information is information indicating in which one of a plurality of risk assessment ranges an indicator calculated for the at least one of the plurality of pieces of equipment is included, the indicator being used to assess the level of the risk, the plurality of risk assessment ranges being created by dividing a possible range in which the indicator fluctuates.

16. The processing system for maintenance management information of a plant according to claim 15,
wherein the assessment information is colors set in association with the plurality of risk assessment ranges and displayable on the monitor, and
wherein the image processing unit is configured to execute processing of rendering one of the colors that indicates one of the plurality of risk assessment ranges in which the indicator calculated for the at least one of the plurality of pieces of equipment is included to the each one of the plurality of blocks.

17. The processing system for maintenance management information of a plant according to claim 8, wherein, when one of the plurality of blocks includes a plurality of pieces of equipment out of the plurality of pieces of equipment included in the plant, the image processing unit is configured to execute image processing so that the one of the plurality of blocks is displayed with the assessment information based on an integrated value of the risk that is calculated for each one of the plurality of pieces of equipment attached thereto.

18. The processing system for maintenance management information of a plant according to claim 8, wherein, when the three-dimensional image is displayed on the monitor by the output control unit, the image processing unit is configured to perform image processing of attaching, to one of the plurality of pieces of equipment that is displayed in the three-dimensional image, equipment assessment information indicating a result of assessing highness of the occurrence frequency when the one of the plurality of pieces of equipment is equipment related to the accident-causing event, or a result of assessing highness of the failure probability of normal operation when the one of the plurality of pieces of equipment is the safety device.
